(19) United States
(12) Patent Application Publication
(10) Pub. No.: US 2025/0084817 A1
(43) Pub. Date: Mar. 13, 2025

(54) Turbine Assembly, System and Method

(71) Applicant: Edward Anthony Hill, Carlsbad, CA (US)

(72) Inventor: Edward Anthony Hill, Carlsbad, CA (US)

(21) Appl. No.: 18/882,163

(22) Filed: Sep. 11, 2024

Related U.S. Application Data
(60) Provisional application No. 63/538,051, filed on Sep. 12, 2023.

(51) Int. Cl. F03B 3/14; F03B 11/00

(52) U.S. Cl. CPC F03B 3/145; F03B 11/008; F05B 2260/506; F05B 2260/70; F05B 2260/83

(57) ABSTRACT

A turbine assembly includes a shaft having an axis, a single cam with a cam profile and coupled to the shaft, and at least one foil coupled to the cam and having an axis. A variable pitch mechanism is coupled to at least one of the at least one foil or the single cam and is configured to adjust a position of the at least one foil while the at least one foil simultaneously rotates about the shaft. At least one of the shaft, the variable pitch mechanism, and the at least one foil is configured to be automatically actuated in a direction parallel to the axis of the shaft.

### CROSS-REFERENCE TO RELATED APPLICATION

This application claims priority to and the benefit of U.S. Provisional Application Ser. No. 63/538,051, filed on Sep. 12, 2023, entitled “Turbine Assembly, System and Method.” The entire content of the application is incorporated herein by reference in its entirety.

### FIELD OF THE DISCLOSURE

The present disclosure generally relates to a turbine assembly and, in particular, a variable pitch turbine assembly and system and related methods.

### BACKGROUND

Known methods of extracting power from water or wind make use of kinetic energy contained in tidal, river or, or air currents to provide a clean and renewable energy source. One approach to harness this energy is to use hydrokinetic or tidal turbine assemblies and/or wind turbine assemblies. Conventional tidal and wind turbine assemblies must be designed to withstand forces generated by a maximum wind and/or water speed, for example, and may not survive during use in such conditions and/or avoid debris causing damage to parts of the turbine assemblies. In addition, many conventional turbine assemblies are fixed-pitch turbine assemblies that are unable to dynamically adapt to changes in extreme wind and/or water speeds during use and therefore are susceptible to damage and/or destruction. Lastly, horizontal-axis, variable pitch turbines have proven to enable economically viable wind energy, and can adapt to extreme wind speeds, but may prove too costly for application to water currents due to the submergence of complex mechanisms and electrical components.

### SUMMARY

In accordance with a first aspect, a turbine assembly comprises a shaft having an axis, a single cam with a cam profile and coupled to the shaft, and at least one foil coupled to the cam and having an axis. The at least one foil is configured to rotate about or parallel to the axis of the at least one foil while simultaneously rotating about the axis of the shaft. A variable pitch mechanism is coupled to at least one of the at least one foil or the single cam and is configured to adjust the rotational position of the at least one foil about the axis of the at least one foil while the at least one foil simultaneously rotates about the shaft. Further, at least one of the shaft, the variable pitch mechanism, or the at least one foil is configured to be actuated in at least one of a vertical direction or direction parallel to the axis of the shaft.

According to another aspect, a turbine system comprises an actuator, a turbine assembly configured to be coupled to the actuator, and at least one sensor. The actuator automatically actuates the turbine assembly in a vertical direction in response to an input sensed by the at least one sensor.

According to yet another aspect, a variable pitch mechanism is configured for a hydrokinetic turbine assembly, and comprises at least one actuator coupled to a cam of the hydrokinetic turbine assembly. The at least one actuator automatically actuates the cam to move the cam in a vertical direction and to disengage the cam from the turbine assembly while at least one foil of the hydrokinetic turbine assembly initially continues to rotate about an axis of a foil.

According to yet another aspect, a method of automatically adjusting a vertical or a rotational position of a turbine assembly comprises sensing an input detected by at least one sensor of a turbine system. In response to sensing the input, the method further comprises automatically actuating at least one of: (1) a shaft of a turbine assembly via an actuator to move at least one of the shaft or the turbine assembly; (2) a single cam of the turbine assembly to move and disengage the single cam from a variable pitch mechanism of the turbine assembly; or (3) at least one foil of the turbine assembly by the variable pitch mechanism to adjust a rotational position of the at least one foil of the turbine assembly about an axis of the at least one foil.

In some preferred forms, the single cam may be configured to alter an angle of attack (AOA) of the at least one foil and achieve an optimal angle of attack (AOA) over a 360 degree rotation of the least one foil.

In another preferred form, the turbine assembly may further comprise a follower arm and a follower wheel, and the follower arm may have a first end coupled to at least one of the foil which is attached via a bearing to the rotor of the at least one foil. A second end may be coupled to the follower wheel, the follower wheel may contact the cam, or the second end of the follower arm, and be configured to contact one or more of linkage or a gear train disposed on the single cam.

In another preferred form, the at least one foil may comprise a plurality of foils, each foil of the plurality of foils coupled to the single cam, and the variable pitch mechanism may be coupled to at least one of each foil of the plurality of foils or the single cam and configured to adjust one or more of a rotational position or a vertical position of each foil of the plurality of foils while each foil of the plurality of foils simultaneously rotates about the shaft.

In yet another preferred form, the at least one foil may include a first end coupled to the at least one projection extending from the cam and a second end disposed in fluid, such as water, and optionally a spray fence.

In yet another preferred form, a variable pitch mechanism may be coupled to at least one of the at least one foil or the single cam and may comprise at least one of:

(1) a motor disposed on the at least one foil for actuating the rotational position of the at least one foil; (2) one or more of a spring, a damper, or another passive mechanical element configured to control centrifugal and/or fluid dynamic forces actuating the at least one foil; and (3) a follower arm coupled to the cam, and a follower wheel coupled to the follower arm, and the follower arm or the follower wheel configured to contact the at least one foil to passively adjust at least one of a rotational position or an angle of attack (AOA) of the at least one foil.

In another preferred form, one or more of: (1) the turbine assembly may be a hydrokinetic turbine assembly; (2) the single cam may include a variable surface cam; (3) the turbine assembly may further comprise one or more of a vane or actuator to clock the single cam; or (4) the turbine assembly may be coupled to a hull.

In still other forms, the turbine system may further comprise a tip-speed-ratio (TSR) modulation system comprising one or more of a generator coupled to a shaft of the turbine assembly and configured to change shaft power to electrical power, and an actuator configured to alter a depth of the at least one foil.

In yet another form, the turbine system may comprise an anchor system coupled to the turbine assembly. The anchor system may include a floating platform having at least one sensor and an anchor line coupled to an anchor point disposed under fluid and/or within the fluid flow on a projection of the turbine assembly in a plane normal to a flow direction or the floating platform and aligned with a center of drag of the turbine. The anchor point and the anchor line may be configured to one or more of: (1) move in at least one of a vertical direction or a direction parallel to the axis of the shaft when the shaft is actuated in the vertical direction or a direction parallel to the axis of the shaft; or (2) be entirely removed from the fluid upon sensing debris.

In another form, the at least one sensor may comprise at least one of a flow velocity sensor, a debris sensor, or a surface sensor, a shaft rpm sensor, each of which may be coupled to a data acquisition unit coupled to the turbine assembly.

In yet another preferred form, the flow velocity sensor may include at least one of a mechanical sensor, a radar, an ultrasonic sensor, an inductive sensor, or an accelerometer, the debris sensor includes at least one of a sonar sensor, a camera, an ultrasonic sensor, a below-water sonar system, a below-water imaging system, a tension sensor, an accelerometer, and the surface sensor includes at least one of pressure column, an accelerometer, a camera, or thermal imaging camera.

In still another preferred form, the input may be sensed by the at least one sensor is debris.

In still another preferred form, the actuator may comprise at least one of: (1) a motor configured to be coupled to the cam of the hydrokinetic turbine assembly; (2) a spring and/or a damper coupled to the cam; or (3) a solenoid coupled the cam.

In yet another form, the turbine assembly may further comprise a follower arm and a follower wheel. The follower arm may have a first end coupled to the at least one the foil and a second end coupled to the follower wheel. The follower wheel may be configured to contact one or more of the single cam, linkage or a gear train disposed on the single cam.

In yet another form, the turbine assembly may be a hydrokinetic turbine assembly, and the at least one foil may include a first end coupled to the at least one rotor extending from the cam and a second end disposed in water.

In another form, the at least one foil may comprise a plurality of foils, each foil of the plurality of foils may be coupled to the cam. The variable pitch mechanism may be coupled to one of each foil of the plurality of foils or the single cam and may be configured to adjust a position of each foil of the plurality of foils while each foil of the plurality of foils simultaneously rotates about the shaft.

In another form, sensing an input detected by at least one sensor of a turbine system may comprise sensing debris, a maximum condition of water current, or a maximum condition of wind via one or more of a flow fluid velocity sensor, a debris sensor, or a surface sensor.

In yet another form, automatically actuating at least one of a shaft of a turbine assembly via an actuator to move the shaft may comprise automatically actuating the shaft of the turbine assembly via the actuator to move the shaft in an upward and/or vertical direction away from the input sensed or the turbine assembly completely out of the water.

In yet another form, automatically actuating a single cam of the turbine assembly to move and disengage the single cam from the shaft of the turbine assembly may comprise automatically actuating a single cam of the turbine assembly to move and disengage the single cam from the shaft of the turbine assembly in a vertical direction using an actuator.

In still yet another form, automatically actuating at least one foil of the turbine assembly to adjust one or more of a rotational position or a vertical position of the at least one foil of the turbine assembly while the at least one foil simultaneously rotates about the shaft of the turbine assembly may comprise automatically actuating the at least one foil using the variable pitch mechanism coupled to the at least one foil, the variable pitch mechanism including at least one of: (1) a motor disposed on a rotor of the turbine assembly; or (2) a follower arm and a follower wheel coupled to the follower arm and configured to contact a linkage or a geartrain to passively adjust the rotational position of the at least one foil.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicative of the presence or absence of particular elements in any of the example embodiments, except as may be explicitly delineated in the corresponding written description. Also, none of the drawings is necessarily to scale.

FIG. 1 is a perspective view of a turbine system according to one aspect of the present disclosure;

FIG. 2 is a perspective view of a portion of the turbine system of FIG. 1;

FIG. 3 is a perspective view of a turbine assembly according to another aspect of the present disclosure;

FIG. 4A is a perspective view of the turbine assembly of FIG. 3, with a cam translating to disengage from the turbine assembly;

FIG. 4B is a perspective view of the turbine assembly of the present disclosure having a solenoid and an optional biasing member;

FIG. 4C is a perspective view of the turbine assembly of FIG. 3, with a different cam having variable profiles according to another aspect of the present disclosure;

FIG. 5 is a perspective view of another portion of the turbine assembly according to another aspect of the present disclosure, including an actuator on each foil;

FIG. 6A is a perspective view of a foil of the turbine assembly of the present disclosure;

FIG. 6B is a perspective view of a portion of the foil of FIG. 6A, where the turbine assembly is operating at maximum foil depth and depicting a portion of the foil above a surface of water and another portion of the foil below the surface of water;

FIG. 6C is a top view of the foil of FIG. 6A, depicting a prescribed relative rotational position of the above the surface of water portion of the foil relative to the below the surface of water portion of the foil, as well as the direction of rotation of the turbine assembly for a prescribed direction of fluid flow;

FIG. 6D is another perspective view of the foil of FIG. 6A relative to a turbine shaft, depicting the foil having a spray fence;

FIG. 7 is another side view of the turbine system of FIG. 1;

FIG. 8 is another side view of the turbine system of FIG. 1 with an anchoring system coupled thereto according to another aspect of the present disclosure;

FIG. 9 is a portion of an anchor system of the turbine system of FIG. 8 in a fully submerged position;

FIG. 10 is a portion of the anchor system of the turbine system of FIG. 8 at a maximum vertical position;

FIG. 11 is a cross-sectional view of a portion of a turbine assembly of FIG. 1 with a cam clocking mechanism;

FIG. 12 is a graphical representation depicting an angle of attack of at least one foil of the turbine assembly of the present disclosure relative to an angle theta, which is representative of an angle of a rotor of the turbine assembly relative to a defined initial rotor angular position relative to a shaft of the turbine assembly and/or an angle of at least one foil of the turbine assembly relative to a defined initial angular position of the at least one foil relative to the shaft of the turbine assembly;

FIG. 13 is a perspective view of a portion of the turbine assembly of FIG. 1 and the anchor system;

FIG. 14 is a cross-sectional view of a spring assembly that may be used with the turbine assembly of the present disclosure, the spring assembly in a first position and a second position;

FIG. 15 is a side, perspective view of the turbine assembly of the present disclosure coupled to a hull; and

FIG. 16 is a bottom perspective view of the turbine assembly coupled to the hull.

### DETAILED DESCRIPTION

Generally, a novel variable-pitch, vertical-axis, surface-piercing, vertically-actuated current energy converter turbine assembly is disclosed, which offers an alternative to existing fixed pitch control approaches or variable-pitch, horizontal axis control approaches. As described in detail below, this new architecture for a current energy converter turbine assembly enables proactive debris avoidance, improved survivability, reduced need for site characterization, increased capacity factor, and possible reduction of a levelized cost of energy (LCOE). The surface-piercing feature of the new turbine assembly includes being vertically actuated automatically to remove the turbine assembly blades or foils from the flow of water during extreme conditions. The variable-pitch turbine assembly may operate at any scale and utilizes an inexpensive mechanical pitching system, as described more below. Low-cost benefits are maintained with the new turbine assembly of the present disclosure while improving performance as compared to some existing fixed pitch turbine assemblies.

More specifically, a turbine assembly is disclosed and includes a shaft having an axis, a single, non-rotating cam with a cam profile and coupled to the shaft, and at least one foil coupled to the cam and having an axis. A variable pitch mechanism is coupled to at least one of the at least one foil or the single cam and configured to adjust a pitch of the at least one foil while the at least one foil simultaneously rotates about the shaft. In addition, at least one of the shaft, the variable pitch mechanism, one or more foils, or the entire turbine is configured to be actuated in a direction parallel to the axis of the shaft, such as a vertical direction, to remove at least one of the shaft, the variable pitch mechanism, the one or more foils, or the entire turbine completely removed from fluid flow, such as water, to avoid debris and improve survivability, for example.

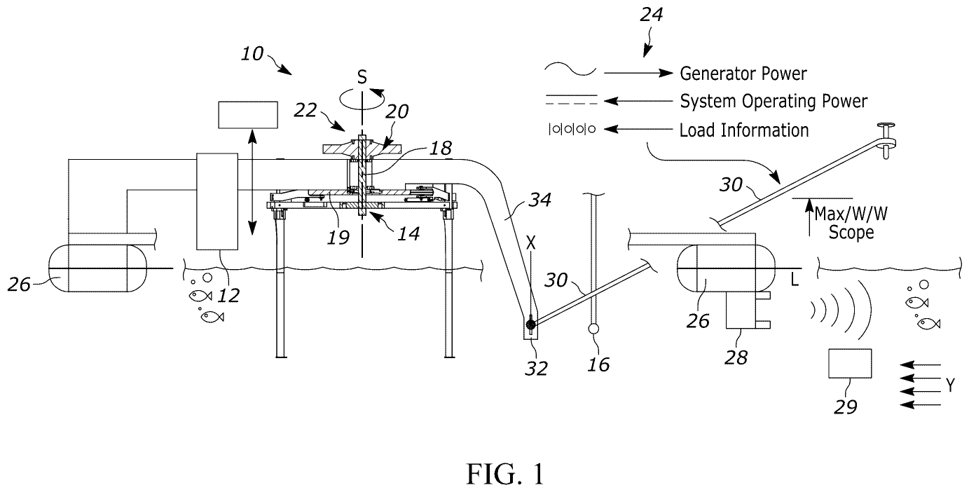

Referring now to FIG. 1, a turbine system 10 according to the present disclosure is depicted. The turbine system 10 includes an actuator 12, such as vertical actuation mechanism or a depth actuator, and a turbine assembly 14 coupled to the actuator 12, as explained more below. In this example, the turbine assembly 14 is a (near) vertical-axis hydrokinetic turbine assembly. The turbine system 10 also includes at least one sensor 16 coupled to a portion of the turbine assembly 14, such that the actuator 12 actuates the turbine assembly 14 in a vertical direction in response to an input sensed by the at least one sensor 16, as also explained more below. The turbine assembly 14 includes a shaft 18 and a variable pitch mechanism 19 that adjusts a pitch of at least components of the turbine assembly 14 and/or the entire turbine assembly 14, as explained more below. So configured, the variable pitch mechanism 19 is also configured to be actuated in the vertical direction, such a parallel to an axis S of the shaft 18.

As also depicted in FIG. 1, the turbine system 10 further includes a generator 20 that is coupled to the shaft 18. The generator 20 along with the actuator 12 together form a tip-speed-ratio (TSR) modulation system 22. The generator 20 may apply electric power to the shaft 18 or alter electrical power output in response to power input from the shaft 18. In addition, the generator 20 turns rotating mechanical shaft power to electrical power. Further, the actuator 12 is configured to alter a depth of the turbine assembly 14 (including the shaft 18) in the water, such as in response to change in current speed or an extreme or maximum condition of the water in response to an input from the at least one sensor 16, for example. The at least one sensor 16 may include a below-water sonar system (e.g., to detect partially or fully submerged debris), a below water imaging system (e.g., to detect fully or partially submerged debris), a tension sensor (e.g., to detect abnormal anchor line force increases due to debris), accelerometers (e.g., to detect debris impacts), and/or a thermal imaging camera.

In addition, and in one example, the actuator 12 alters the depth of the turbine assembly 14 such that at least one component of the turbine assembly 14, or the entire turbine assembly 14, is completely removed from the flow of water. In another example, the actuator 12 alters the depth of the turbine assembly 14 to adjust an operating tip-speed-ratio (TSR). Specifically, the vertical position of the shaft 18 and the turbine assembly 14, for example, are incrementally adjusted, such as by small amounts, as needed to maintain a constant TSR in a scenario where the current speed of the water and/or fluid changes slowly. In another example, the vertical position of the shaft 18 and the turbine assembly 14, for example, are adjusted as needed to maintain a constant TSR in a scenario where the load demand changes. This is a predominant use mode of the turbine assembly 14. Removing the entire turbine assembly 14 from the flow of the fluid, e.g., water, such as when the current of the water is too fast, is a less frequent operation. In addition, the modulation of the turbine assembly 14 tip-speed-ratio and/or power output is performed by one or more of open-loop or closed-loop known control methods.

In this example, the turbine system 10 further comprises an anchor system 24 that is coupled to the turbine assembly 14. Specifically, the anchor system 24 includes a floating platform 26, such as pontoon or a boom in one example, including at least one sensor 28. In this example, the floating platform 26 is included on either side of the turbine assembly 14, as depicted in FIG. 1. In addition, an anchor line 30 is coupled to an anchor point 32 disposed on a projection 34 of the turbine assembly 14 in a plane X normal to a flow direction Y or a lateral axis L of the floating platform 26. So configured, the anchor point 32 and the anchor line 30 are configured to move in at least one of a vertical direction or a direction parallel to an axis S of the shaft 18 when the shaft 18 is actuated in the vertical direction or a direction parallel to the axis of the shaft 18. In addition, the at least one sensor 28 may be a debris sensor and the input sensed by the at least one sensor 28 coupled to the floating platform 26 may be debris.

In addition, electrical cables on the anchor line 30 may provide power to run the system, such as from an onshore power supply. Power to run the system may also be supplied by a battery or batteries on the floating platform. The electrical cables on the anchor line 30 may also transmit generator power to shore, as noted in FIG. 1. The load information referred to may also be transmitted via electrical cables on the anchor line 30 and may include grid, battery, or other electrical load information. Load information may also be transmitted wirelessly. The anchor system 24 including the anchor line 30 and related cables for signals and power would move out of the water in the event debris is sensed, such as by the at least one sensor 28. This would be enabled in a scenario in which the anchor line 30 securing point is above water, e.g., such as a tree, a bridge, or a structure built specifically for this purpose.

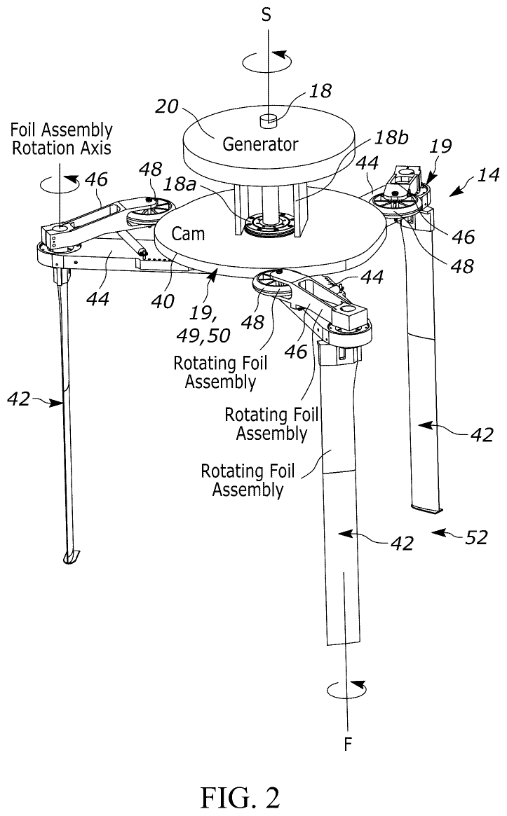

Referring now to FIG. 2, the turbine assembly 14 of FIG. 1 is depicted according to another aspect of the present disclosure. The turbine assembly 14 includes the shaft 18 having the axis S and a single cam 40 with a cam profile and coupled to a bearing housing 18b. A main shaft bearing 18a is disposed around the shaft 18, and the bearing housing 18b surrounds the main shaft bearing 18. While the single cam 40 is coupled to the bearing housing 18b, the cam 40 does not rotate unless flow direction changes. For example, when the flow direction and/or current of the fluid, such as water, has a constant direction, such as a river, the cam 40 does not rotate. However, when the flow direction and/or current of the fluid has various directions, such as in a tidal current, the cam 40 may have one position for incoming current and another position, such as being rotated 180 degrees, or another optimal rotation for a new current direction. This clocking of the cam 40 to align with the direction of the current may be accomplished using a mechanical vane or an electric actuator, as described more herein.

The turbine assembly 14 further includes at least one foil 42 coupled to the cam 40 and having an axis F. The at least one foil 42 is configured to rotate about or parallel to the axis F of the at least one foil 42 while simultaneously rotating about the axis S of the shaft 18. The single cam 40 is configured to alter an angle of attack (AOA) of the at least one foil and achieve an optimal angle of attack (AOA) over a full rotation, such as a 360 degree rotation, of the at least one foil 42. This enables lift force of the at least one foil 42 to be optimized, such as maximized for the at least one foil 42 at each point of its travel over a full rotation about the axis S of the shaft 18.

The turbine assembly 14 further includes the variable pitch mechanism 19 that is coupled to the at least one of the at least one foil 42 or the single cam 40 and configured to adjust the pitch of the at least one foil 42 while the at least one foil 42 simultaneously rotates about the shaft 18. In addition, at least one of the shaft 18, the variable pitch mechanism 19, each foil 42, or the entire turbine assembly 14, is configured to be actuated in at least one of a vertical direction or a direction parallel to the axis S of the shaft 18 by the actuator 12 (FIG. 1), for example. In this way, at least one of the shaft 18, the variable pitch mechanism 19, each foil 42, or the entire turbine assembly 14 moves in the vertical direction, for example, to be removed from the fluid flow, such as water flow. In another example, the entire turbine assembly 14 moves incrementally to adjust the power captured by the foils 42 and input to the shaft 18.

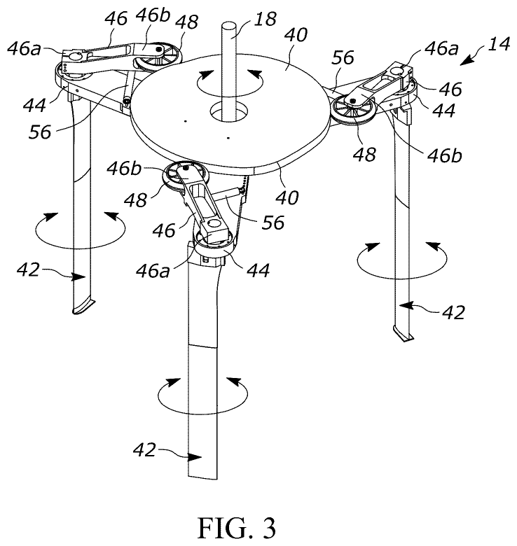

Referring now to FIGS. 2 and 3, at least one rotor 44 extending from the single cam 40. In addition, in one example, the variable pitch mechanism 19 includes one or more of a follower arm 46, a follower wheel 48, and a linkage 49 or geartrain 50 disposed on the single cam 40, as depicted in FIG. 2. A person having ordinary skill in the art will understand structural features of the linkage 49 and geartrain 50 and how they may be implemented instead of the depicted follower arm approach, for example. In this example, the follower wheel 48 is configured to contact one or more of the follower arm 46 linkage 49 or the gear train 50 disposed on the single cam 40 to help control the pitch of the at least one foil 42, for example. Further, the follower arm 46 includes a first end 46a coupled to the at least one foil 42, which is attached to the at least one rotor 44 via a bearing mounted on the at least one rotor 44. A second end 46b of the follower arm 46 is coupled to the follower wheel 48 (FIG. 3). As depicted in FIGS. 2-3, for example, the at least one rotor 44 may include three rotors 44 and, thus, three follower arms 46 coupled to the three foils 42 and three follower wheels 48. It will be understood that more or fewer rotors 44, foils 42, follower arms 46, and follower wheels 48 may alternatively or additionally be used and still fall within the scope of the present disclosure.

In addition, as further depicted in FIGS. 2 and 3, the at least one foil 42 may include a plurality of foils 52, such as three foils 42. Each foil 42 of the plurality of foils 52 is coupled to the single cam 40, and the variable pitch mechanism 19, such as one or more of the follower arm 46, the follower wheel 48, and the linkage 49 or geartrain 50, in this example, may be coupled to at least one of each foil 42 of the plurality of foils 52 or the single cam 40. The variable pitch mechanism 19 is configured to adjust the pitch of each foil 42 while each foil 42 of the plurality of foils 52 rotates about the shaft 18. While the plurality of foils 52 includes three foils 42 in the example of FIGS. 2 and 3, for example, it will be understood that more or fewer foils 42 may alternatively and/or additionally be used and still fall within the scope of the present disclosure.

As also depicted in FIG. 3, and in one example, the variable pitch mechanism 19 includes a passive mechanical elements 56, such as a spring 56 and/or a damper, that is coupled to the single cam 40. In one example, the spring is a bias spring. In another example, the spring may be a tension spring assembly or a compression spring. The compression spring may be conical, which would also enable a non-linear force deflection curve, similar to a spring assembly depicted in FIG. 17 and described more below. The passive mechanical elements 56 are configured to control centrifugal and/or hydrodynamic forces actuating the at least one foil 42, for example. Said another way, the passive mechanical elements 56 are actuated by centrifugal and/or hydrodynamic forces, or aero forces for wind.

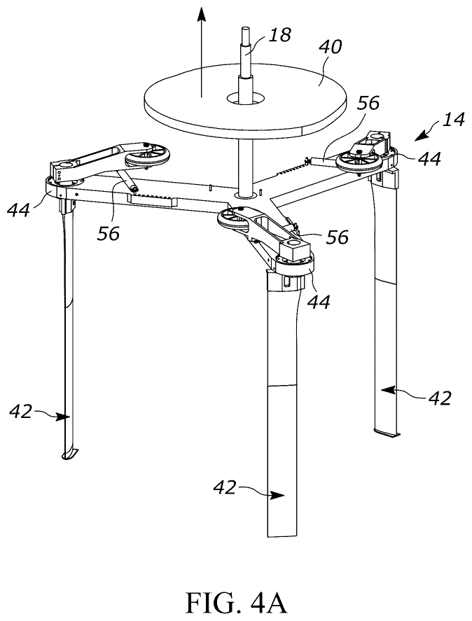

Referring now to FIG. 4A, the turbine assembly 14 of the turbine system 10 of FIG. 1 is again depicted. In this example, the single cam 40 is depicted being actuated to move in the vertical direction away from the at least one rotor 44 and be disengaged from the at least one follower wheel 48. This occurs while the at least one foil 42 of the turbine assembly 14 initially continues to rotate about the axis S (FIG. 2) and axis F (FIG. 2) of the at least one foil 42, such as in a scenario where wind or current became too strong and would otherwise damage the turbine assembly 14 and/or turbine system 10. The rotation of the at least one foil 42 will then slow and the at least one foil 42 (and/or each foil) will no longer rotate about the shaft 18, for example. The leading edges of the at least one foil 42 will then face into the water current or wind and no power will be generated. Rather, the turbine assembly 14 is then in a survival mode. While the turbine assembly 14 of the turbine system 10 is depicted relative to a water or hydrokinetic application, it will be appreciated that the turbine assembly 14 of the turbine system 10 may also be used and/or application to wind and still fall within the scope of the present disclosure.

In addition, the single cam 40 can translate directly, or upwardly such as in the vertical direction explained above by rotating on a screw-mechanism. The at least one foil 42 and/or multiple foils then rotated about their own axes unconstrained and no power is generated, which is the turbine assembly 14 survival mode. Alternatively, as depicted in FIG. 4C, the single cam 40 can translate upwardly, such as in the vertical direction, to enable an adjustment to the cam profile/pitching law to enable improved operation in specific flow regimes, for example. This survival mechanism may be used for hydrokinetic or wind power, for example.

The turbine assembly 14 may include one of a tidal or hydrokinetic turbine assembly or a wind turbine assembly and still include these features. In one example, the single cam 40 is actuated to move in the vertical direction and be disengaged from the at least one follower wheel 48 by way of a motor of the turbine system 10 or other means, for example. The variable pitch mechanism 19 may additionally and alternatively include the other components described herein.

More generally, the variable pitch mechanism 19 configured for the turbine assembly, such as either the wind turbine assembly or the hydrokinetic turbine assembly, comprises the at least one actuator coupled to the single cam 40 of the turbine assembly 14. So configured, the at least one actuator in this example actuates the single cam 40 to move the single cam 40 in the vertical direction and disengage from at least one follower wheel 48. The at least one foil 42 can then still spin about the foil axis F, unconstrained, and the turbine assembly 14 generates minimal power.

Referring now to FIG. 4B, in yet another example, the at least one actuator of the variable pitch mechanism 19 additionally and/or alternatively includes a solenoid 58 also coupled to the single cam 40. The solenoid 58 may be coupled to bearing housing 18b and actuate the single cam 40 directly and essentially be another electric motor. Alternatively, and in another example, the solenoid 58 may be a release mechanism to allow stored spring force to be released to actuate. In addition, an optional spring 59 may be disposed on the cam 50 next to the solenoid 58.

Referring now to FIG. 4C, the turbine assembly 14 of the turbine system 10 of FIG. 1 is again depicted. In this example, a single cam 40a is depicted but in this example has variable profiles. The single cam 40a translates up/down and/or in the vertical direction to effectively run on a different cam (and therefore adjust pitching law). One exemplary implementation includes a continuously sloped cam surface with no discrete steps between the cams.

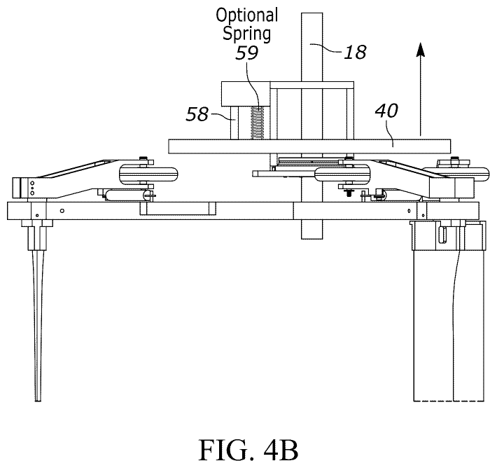

Referring now to FIG. 5, the turbine assembly 14 is again depicted and includes the three foils 42, each of which is coupled via an intermediate bearing to one of the rotors 44 of the turbine assembly 14. In this example, a motor 60 is coupled to one or more of at least one rotor 44 or at least one foil 42 for actuating the rotational direction, such as the pitch, of the at least one foil 42. In this example, a motor 60 is coupled to at least one of each of the three rotors 44 or each of the three foils 42. Further, in this example, the variable pitch mechanism 19 of the turbine assembly 14 includes at least one of the motors 60 coupled to the at least one foil 42.

As will be appreciated at least in view of the foregoing description, the one or more of the rotational position and/or the pitching of the at least one foil 42 may be actuated or powered by an additional power source, such as the motor 60 disposed on the rotor 44 and coupled to the at least one foil 42. In addition, and as depicted in FIG. 2, the pitching of the at least one foil 42 may be passive, or actuated by centrifugal and hydrodynamic forces that are further controlled by the spring 56 and/or the spring and damper 56 or other passive mechanical elements. In another example, the pitching of the at least one foil 42 may be passive and utilize the single cam 40, such as the cam 40 clocked with a mechanical vane or with a motor and one or more sensors to align optimally with flow direction, for example. In still another example, the pitching of the at least one foil 42 may again be passive and accomplished by means of the linkage 49, the single cam 40, the follower arm 46, and the follower wheel 48. The pitching of the at least one foil 42 and all the foils 42 of the turbine assembly 14 may include one or more of all the aforementioned pitching methods and still fall within the scope of the present disclosure.

In addition, in one example, the variable pitch mechanism 19 is located above the water level, where it is not subjected to hydraulic drag forces and corrosive saltwater. However, the variable pitch mechanism 19 may alternatively be partially or fully disposed in the water, if desired, and still operate as described above. Further, the turbine assembly 14 may operate with the at least one foil 42 and all of the foils 42 fully submerged in water or another fluid or partially submerged in water or another fluid.

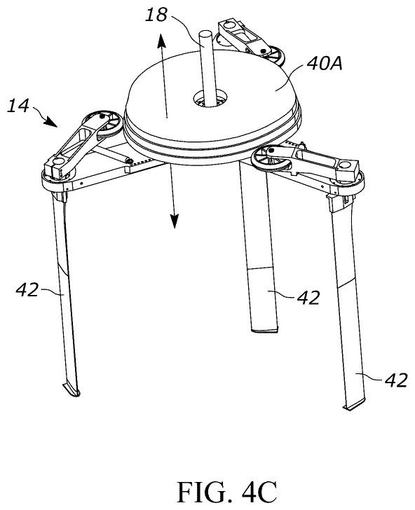

Referring now to FIG. 6A, one foil 42 of the turbine assembly 14 is depicted. The foil 42 includes a first end 42a coupled to the at least one rotor 44 via an intermediate bearing 42c and a second end 42b configured to be disposed in water when the turbine assembly 14 is a hydrokinetic or tidal turbine assembly. In addition, the second end 42b includes an end plate 62 to reduce losses due to vortex shedding, for example. The shape of the 42 may be symmetrical or asymmetrical and may vary along the length of the foil 42. Further, the attachment of the foil 42 to the turbine assembly 14 is designed so that a length of the foils 42 match an operating flow regime. In one example, and more specifically, the foils 42 may be interchanged with a foil having a longer length or a foil having a shorter length to readily adapt to various and/or different flow regimes, for example. In addition, the foil 42 is near-vertical and may operate sometimes in a surface-piercing manner, with actuated or passive variable pitch mechanism 19 (described above) located above the water level, for example. The turbine assembly 14 and thus the variable pitch mechanism 19 coupled thereto is vertically actuated, such as by one or more of the actuator 12, to modulate shaft power, enable survival, and avoid debris, as described herein. The operating state of the generator 20 may further be used to modulate power and control TSR.

Referring now to FIGS. 6B and 6C, a portion of the foil 42 of FIG. 6A is depicted when the turbine assembly 14 is operating with foils partially submerged at a maximum operating depth. A portion 43A of the foil 42 is disposed above a surface of water and another portion 43B of the foil 42 is disposed below the surface of water. A slight angle correction of the foil 42 helps reduce parasitic drag (and therefore improve power generation efficiency), due to the portion 43A of the foil 42 that is nominally above water cutting through the bow wave generated by the turbine assembly 14. A smooth surface 43C or transition is disposed between the portions 43A, 43B of the foil 42 that are disposed above and below the water surface. Referring now to FIG. 6D, the foil 42 of FIG. 6A is again depicted but with a new component, a spray fence 45. The spray fence 45 is used to reduce momentum loss due to spray impact on above-water portions of the turbine assembly 14. This directs spray off of the foil 42 at an angle that minimizes momentum loss and prevents spray from impacting orthogonal surfaces, which would result in higher turbine energy loss due to spray impact, for example.

Further, while FIGS. 1-4 depict a single turbine system 10 or a single turbine assembly 14 and components thereof, it will be appreciated that two turbine systems 10 and two turbine assemblies 14 may be deployed in close proximity to each other and still operate as described herein. In this example, the turbine assemblies 14 may counter-rotate, be phase shifted, and be located in optimal proximity relative to each other as will be understood by persons having ordinary skill.

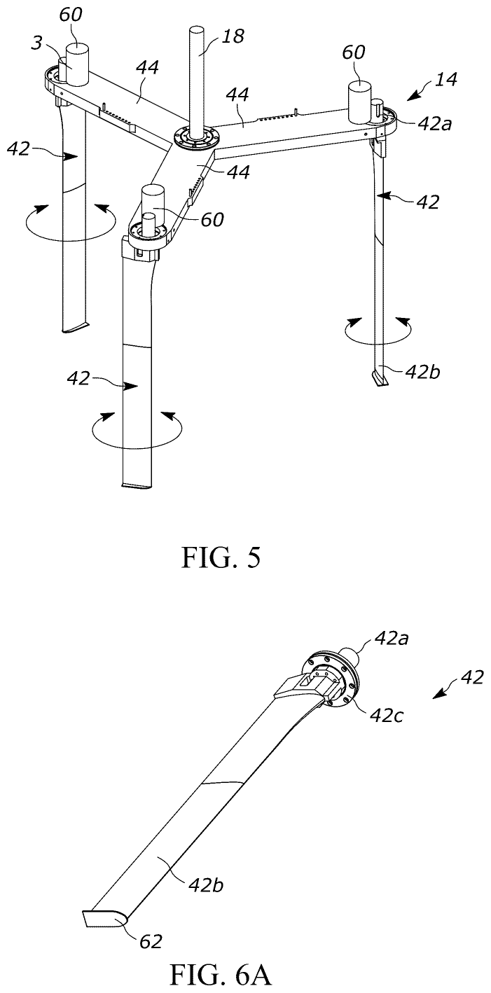

Referring now to FIG. 7, the turbine system 10 is again depicted including the turbine assembly 14 with the variable pitch mechanism 19, the generator 20, the actuator 12, such as the depth actuator, and the at least one sensor 16. Also depicted is a data acquisition unit 64, such as a measurement gauge in one example, adjacent to the generator 20 and coupled to the at least one sensor 16. In this example, the at least one sensor 16 comprises a flow velocity sensor, which may include at least one of a mechanical sensor, a radar, an ultrasonic sensor, a shaft rpm sensor or an inductive sensor. The at least one sensor 16 of the turbine system 10 may also include at least one of a debris sensor 66 or a separate surface sensor 68, both of which are also coupled to the data acquisition 64. A water level 70 is further depicted in FIG. 7, and each of the flow velocity sensor and the debris sensor 66 is disposed within the water under the water level 70, while the surface sensor 68 is disposed at the water level 70. The debris sensor 66 may include at least one of a below-water sonar system (e.g., to detect partially or fully submerged debris), a below water imaging system (e.g., to detect fully or partially submerged debris), a tension sensor (e.g., to detect abnormal anchor line force increases due to debris), and/or a thermal imaging camera. Other sensor technologies found useful in detecting debris may also be employed and still fall within the scope of the present disclosure, as will be understood by persons having ordinary skill in the art.

The debris sensor 66 may also include a sonar sensor, a camera, or an ultrasonic sensor, and the surface sensor 68 may include at least one of a pressure column, an accelerometer, or a camera. In another example, the surface condition may be sensed by an accelerometer or other surface sensor 68 disposed on a floating structure, for example. In another example, an above water sensor 68a (added to FIG. 7) may include an imaging system and/or a thermal imaging camera which may include powered illumination sources of various wavelengths to enable detection of floating debris at night.

The turbine system 10 also includes a controller 72 that is communicatively coupled (by a wired or a wireless network) to the actuator 12, the data acquisition unit 64, and a power unit 74. The controller 72 is also communicatively couples to load information 24 (FIG. 1). The power unit 74 may powered by a land-based power source 24 (FIG. 1) and also be communicatively coupled to the data acquisition unit 64, as depicted in FIG. 7, by one of a wired or wireless communication network, as will be understood by a person having ordinary skill.

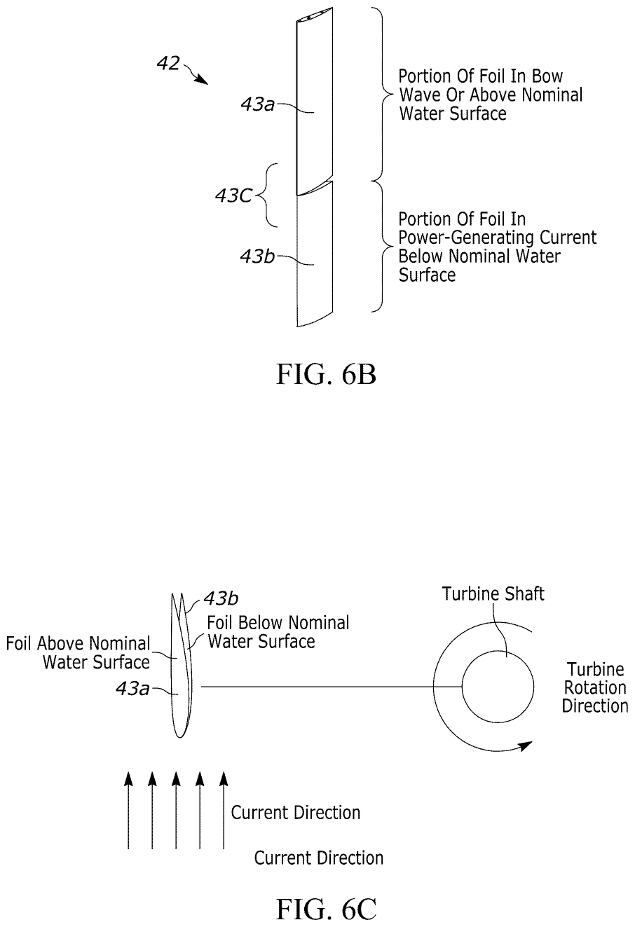

Referring now to FIG. 8, the turbine system 10 is again depicted with the anchor system 24 coupled thereto. In this example, the anchor line 30 is shown again coupled to the anchor point 32 disposed on the projection 34 of the turbine assembly 14 in a plane X normal to a flow direction Y or a lateral axis L of the floating platform 26. So configured, the anchor point 32 and the anchor line 30 are configured to move in at least one of a vertical direction or a direction parallel to an axis S of the shaft 18 when the shaft 18 is actuated in the vertical direction or a direction parallel to the axis of the shaft 18. This aligns a force of the anchor line 30 with a drag force of the turbine assembly 14, thereby reducing induced moments and structural demands on the turbine system 10.

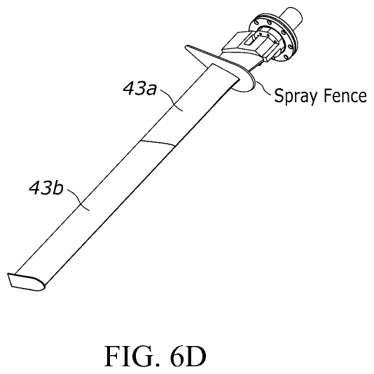

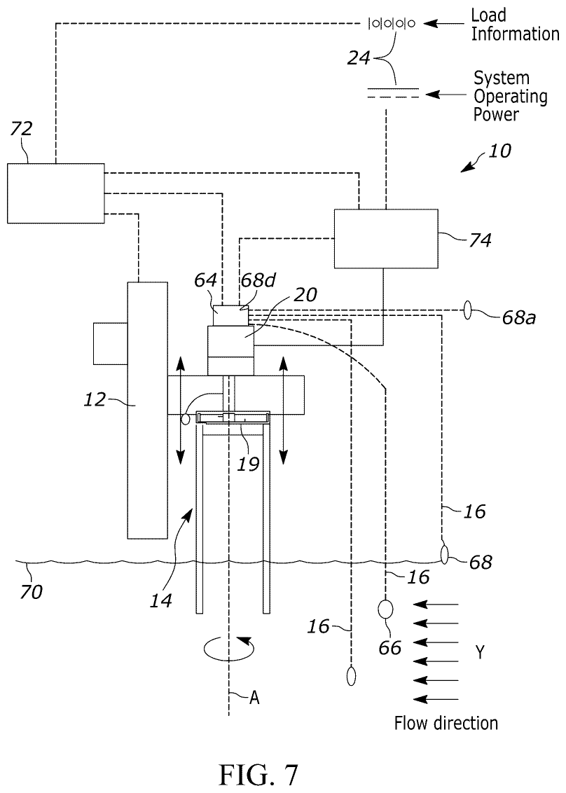

Referring now to FIGS. 9 and 10, close up views of the anchor point 32 of the anchor system 24 are depicted. In FIG. 9, the anchor point 32 with the anchor line 30 extending therefrom is depicted fully submerged within the water and below the water level 70. In FIG. 10, the anchor point 32 with the anchor line 30 extending therefrom is depicted at a maximum vertical height above the water level 70. The projection 34 includes a slot 80 to reduce anchor line scope when the turbine assembly 14 is in the maximum upward (out of water) position depicted in FIG. 10.

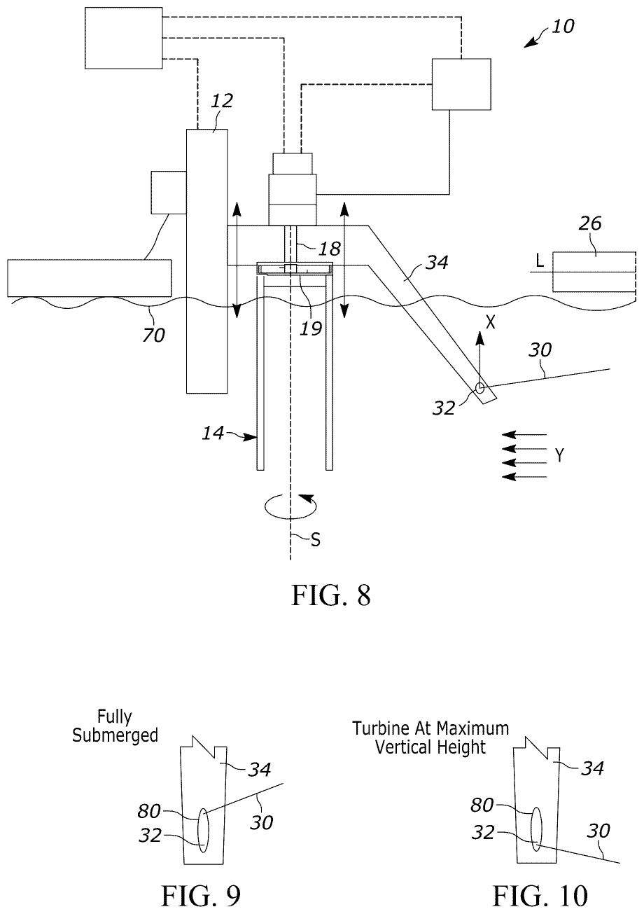

Referring now to FIG. 11, the turbine assembly 14 of the present disclosure is depicted with a cam clocking mechanism 47 coupled to the cam 40 of the turbine assembly 14. The cam clocking mechanism 47 is an alternative cam actuator motor, which can rotate the cam 40 via a pinion and gear teeth on an inner cam annulus.

As explained above, the turbine assembly 14 includes the shaft 18 having the axis, the single cam 40 with a cam profile and coupled to the shaft bearing housing 18a, and the at least one foil 42 coupled to the cam 40 and having an axis. The at least one foil 42 is configured to rotate one of about or parallel to the axis of the at least one foil 42 while simultaneously rotating about the axis of the shaft 18. Still further, a vane 53 is coupled to the cam 40, and a portion of the vane 53 is configured to be disposed in water, as depicted in FIG. 11. The water turns the vane 53 and spins the cam 40. As further depicted in FIG. 11, the turbine assembly 14 also includes at least one rotor 44, the follower arm 146 coupled to the rotor 44, and the follower wheel 48 coupled to the follower arm 46. In this example, the single cam 40 adjusts and/or clocks to align with a direction of the water properly.

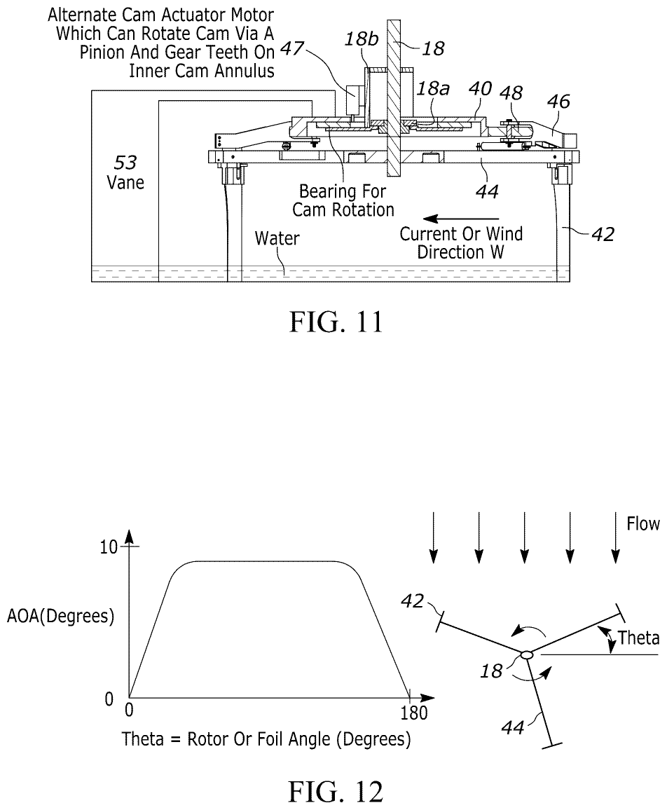

Referring now to FIG. 12, a graphical representation of an angle of attack (AOA) of at least one foil 42 of the turbine assembly 14 of the present disclosure with the variable pitch mechanism 19 configured to adjust the at least one foil 42 is depicted in an upstream 180 degrees of travel. Compared with a fixed pitch turbine assembly, the turbine assembly 14 of the present disclosure maintains the angle of attack (AOA) at a more constant and near optimal value for a significant portion of the upstream travel arc, as depicted in FIG. 12. The AOA is similarly adjusted in the downstream stroke to generate maximal power, reduce torque ripple on shaft 18, and/or avoid power loss. This is accomplished through TSR modulation (e.g., via the generator 20 operating state adjustment and foil depth adjustment with knowledge of load information as explained above) and the aforementioned variable pitch mechanism 19, as also explained above.

In view of the foregoing, it will be appreciated that the foregoing turbine assembly 14 and turbine system 10 may operate according to one or more of the following methods. Specifically, a method of automatically adjusting one or more of a rotational position or a vertical position of the turbine assembly 14 comprises sensing an input detected by at least one sensor 16, 28, 66, 68 of the turbine system 10. The method further comprises automatically actuating at least one of: (1) the shaft 18 of the turbine assembly 14, via an actuator 12 to move the shaft 18 in a direction away from the input sensed; (2) the single cam 40 of the turbine assembly 14 to move and disengage the single cam 40 from the follower wheels 48 of the turbine assembly; and (3) at least one foil 42 of the turbine assembly 14 to adjust a rotational position and/or a vertical position of the at least one foil 42 of the turbine assembly 14.

In one example, sensing an input detected by the at least one sensor 16, 28, 66, 68 of the turbine system 10 comprises sensing debris 29 (FIG. 1) or a maximum condition of water via one or more of a flow velocity sensor 16, a debris sensor 28, 66, or a surface sensor 68. If debris 29 or this condition is not sensed or detected, the turbine assembly 14 will continue to generate power, such as a maximum power, per a normal operating protocol. If the at least one sensor 16 no longer senses an input, indicating that the debris has passed in one example, the turbine assembly 14 will return to its normal operating protocol. If the at least one sensor 16, 28, 66, 68 continues to sense the input detected by the at least one sensor 16, 28, 66, 68, such as continues to sense the debris, for a period of time exceeding a maximum period of time, the turbine system 10 will indicate an error state of the turbine assembly 14 and transmit a notice of the same.

In another example, and in response to detecting an input, such as debris, sensed by the at least one sensor, automatically actuating the at least one of shaft 18 of the turbine assembly 14 via an actuator to move the shaft 18 in a direction away from an input sensed comprises automatically actuating the shaft 18 of the turbine assembly via the actuator 12 to move the shaft 18 in an upward and/or vertical direction away from the input sensed. In another example, automatically actuating the at least one of shaft 18 of the turbine assembly 14 via an actuator to move the shaft 18 in a direction away from an input sensed comprises automatically removing the entire turbine assembly 14 completely from the water at a minimum speed necessary to ensure the debris does not impact any component of the turbine assembly 14 or the anchor line 30.

In yet another example, automatically actuating the single cam 40 of the turbine assembly 14 to move and disengage the single cam 40 from the shaft 18 of the turbine assembly 14 comprises automatically actuating the single cam 40 of the turbine assembly 14 to move and disengage the single cam 40 from the shaft 18 of the turbine assembly 14 in a vertical direction using actuator 58, so that the cam 40 is disengaged from follower wheel 48 and at least one foil 42 of the turbine assembly 14 continues (at least initially) to rotate about an axis of the at least one foil 42 and the shaft 18.

Further, automatically actuating the at least one foil 42 of the turbine assembly 14 to adjust a rotational position, such as a pitch, of the at least one foil 42 of the turbine assembly 14 while the at least one foil 42 simultaneously rotates about the shaft 18 of the turbine assembly 14, 114 comprises automatically actuating the at least one foil 42 using the variable pitch mechanism 19 coupled to the at least one foil 42, the variable pitch mechanism 19 including at least one of: (1) the motor 60 coupled to at least one of the rotor 44 or the foil 42 of the turbine assembly 14; or (2) the follower arm 46 and the follower wheel 48 coupled to the follower arm 46 and configured to contact a linkage 49 or a geartrain 50 to passively adjust a rotational position of the at least one foil 42.

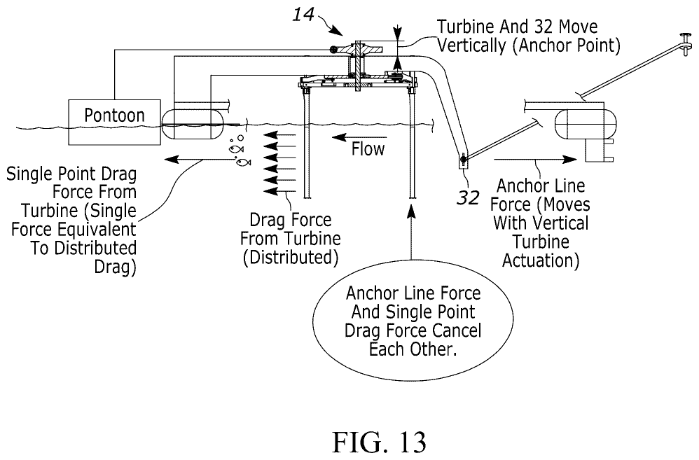

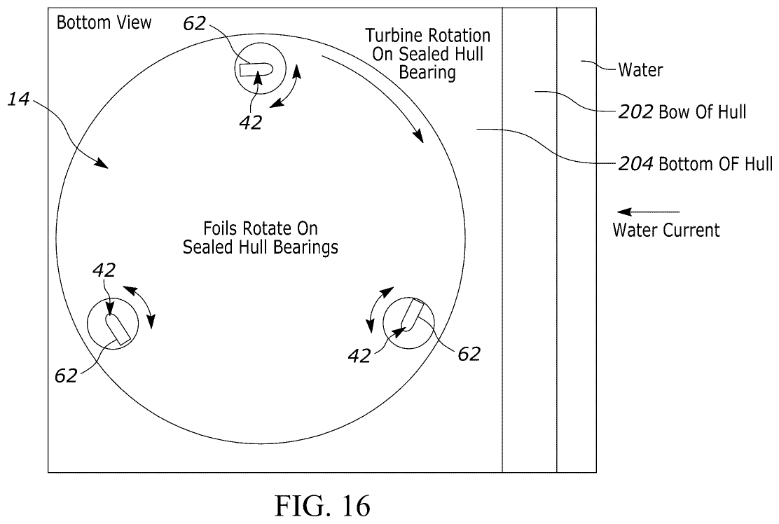

Referring now to FIG. 13, a portion of the anchor system 24 and turbine assembly 14 of the turbine system 10 of FIGS. 1 and 8 is depicted to illustrate the drag force of the turbine assembly 14 relative to the anchor point 32. More specifically, and as depicted in FIG. 16, the anchor point 32 moves with the turbine assembly 14 and is centered on a submerged portion of the turbine assembly 14, such as half way between a surface of the water or water level 70 (see, e.g., FIG. 8) and an end of the at least one foil 42 that is disposed in the fluid, e.g., the water. The turbine assembly 14 has a distributed drag force which convenes into a single point drag force, as depicted. The single point drag force is equivalent to the distributed drag force of the turbine assembly 14. The anchor point 32 includes an anchor line drag force, as further depicted, and moves with vertically actuated turbine assembly (as described above), such that the anchor line force and the single point drag force cancel each other.

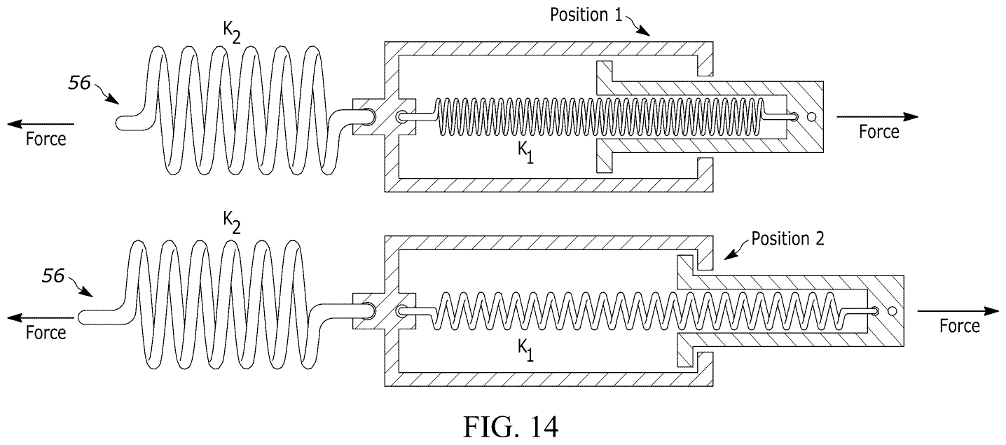

Referring now to FIG. 14, an exemplary passive mechanical element 56, such as the spring 56, that is coupled to the single cam 40 of FIG. 3, for example, is depicted. In this example, the passive mechanical element 56 is a non-linear bias spring assembly 56, which is depicted in first position associated with a biased position and a second position associated with an extended or non-biased position in FIG. 14. More specifically, it is desired to have a light bias spring force for small radius regions of the cam 40, and a higher bias force for larger or largest radius portions of the cam 40. Using the minimum bias force required for each radial follower wheel 48 position on the cam 40 minimizes energy loss in the overall turbine assembly 14 and improves the self-start capability of the turbine assembly 14, which is one of the advantages of using the non-linear bias soring assembly 56 of FIG. 14 compared to a single linear spring, for example. In other examples, the variable pitch mechanism 19 of the turbine assembly 14 may be adapted to use a conical compression spring and still fall within the scope of the present disclosure. Moreover, as one of ordinary skill in the art will understand, other passive mechanical elements 56 different from the non-linear bias spring may be used and still fall within the scope of the present disclosure.

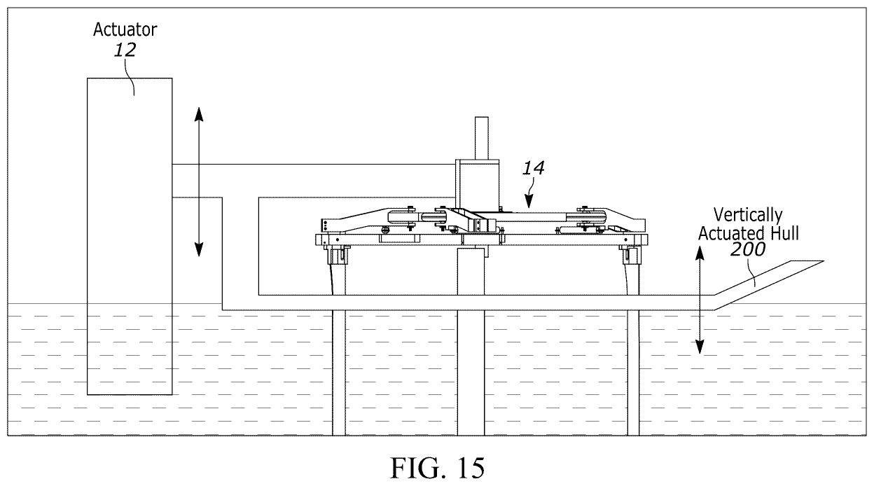

Referring now to FIGS. 15-16, the turbine assembly 14 is depicted coupled to a hull 200. In FIG. 15, the hull 200 is disposed in water with the turbine assembly 14 coupled thereto. The actuator 12 is coupled to the shaft 18 and the hull 200, as explained above, and moves the shaft 18 and the hull 200 in a vertical direction, such as along the axis of the shaft 18. As depicted in FIG. 16, the foils 42 rotate on sealed bearings coupled to the hull 200, thus enabling the plurality of foils 52 to penetrate the hull 200 and capture power from the water flow without allowing water intrusion into the hull 200. The turbine assembly 14 is depicted coupled to the bottom 204 of the hull 200 and the bow 202 of the hull 200. This reduces the parasitic power losses such as when the turbine assembly 14 is operated without the hull 200 and with foils 42 partially-submerged.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one example” or “an example” means that a particular element, feature, structure, or characteristic described in connection with the embodiment is included in at least one embodiment. The appearances of the phrase “in one example” in various places in the specification are not necessarily all referring to the same example.

Some examples may be described using the expression “coupled” and “connected” along with their derivatives. For example, some examples may be described using the term “coupled” to indicate that two or more elements are in direct physical or electrical contact. The term “coupled,” however, may also mean that two or more elements are not in direct contact with each other, but yet still cooperate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

While various embodiments have been described herein, it is understood that the appended claims are not intended to be limited thereto, and may include variations that are still within the literal or equivalent scope of the claims. Although the assembly, system, methods, and elements thereof, have been described in terms of exemplary embodiments, they are not limited thereto. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent that would still fall within the scope of the claims defining the invention.

It should be understood that the legal scope of the invention is defined by the words of the claims set forth at the end of this patent. The appended claims should be construed broadly to include other variants and embodiments of the same, which may be made by those skilled in the art without departing from the scope and range of equivalents of the assembly, system, and methods.

What is claimed:

1. A turbine assembly comprising:
a shaft having an axis;
a single cam with a cam profile and coupled to the shaft;
at least one foil coupled to the cam and having an axis, the at least one foil configured to rotate one of about or parallel to the axis of the at least one foil while simultaneously rotating about the axis of the shaft; and
a variable pitch mechanism coupled to at least one of the at least one foil or the single cam and configured to adjust a rotational position of the at least one foil while the at least one foil simultaneously rotates about the shaft,
wherein at least one of the shaft, the variable pitch mechanism, or the at least one foil is configured to be actuated in one of a vertical direction or a direction approximately parallel to the axis of the shaft.

2. The turbine assembly of claim 1, wherein the single cam is configured to alter an angle of attack (AOA) of the at least one foil and achieve an optimal angle of attack (AOA) over a 360 degree rotation of the least one foil.

3. The turbine assembly of claim 1, the turbine assembly further comprising a follower arm and a follower wheel, the follower arm having a first end coupled to at least one of the foil which is attached via a bearing to the rotor of the at least one foil and a second end coupled to the follower wheel, and the follower wheel contacting the cam, or the second end of the follower arm, and configured to contact one or more of linkage or a gear train disposed on the single cam.

4. The turbine assembly of claim 1, wherein the at least one foil comprises a plurality of foils, each foil of the plurality of foils coupled to the single cam, and the variable pitch mechanism coupled to at least one of each foil of the plurality of foils or the single cam and configured to adjust one or more of a rotational position or a vertical position of each foil of the plurality of foils while each foil of the plurality of foils simultaneously rotates about the shaft.

5. The turbine assembly of claim 4, wherein the at least one foil includes a first end coupled to the at least one projection extending from the cam and a second end disposed in fluid, such as water, and optionally a spray fence.

6. The turbine assembly of claim 1, a variable pitch mechanism coupled to at least one of the at least one foil or the single cam comprises at least one of: (1) a motor disposed on the at least one foil for actuating the rotational position of the at least one foil; (2) one or more of a spring, a damper, or another passive mechanical element configured to control centrifugal and/or fluid dynamic forces actuating the at least one foil; and (3) a follower arm coupled to the cam, and a follower wheel coupled to the follower arm, and the follower arm or the follower wheel configured to contact the at least one foil to passively adjust at least one of a rotational position or an angle of attack (AOA) of the at least one foil.

7. The turbine assembly of claim 1, wherein one or more of: (1) the turbine assembly is a hydrokinetic turbine assembly; (2) the single cam includes a variable surface cam; (3) the turbine assembly further comprises one or more of a vane or actuator to clock the single cam; or (4) the turbine assembly is coupled to a hull.

8. A turbine system comprising:
an actuator;
a turbine assembly configured to be coupled to the actuator; and
at least one sensor,
wherein the actuator actuates the turbine assembly in a vertical direction in response to an input sensed by the at least one sensor.

9. The turbine system of claim 8, further comprising a tip-speed-ratio (TSR) modulation system comprising one or more of a generator coupled to a shaft of the turbine assembly and configured to change shaft power to electrical power, and an actuator configured to alter a depth of the at least one foil.

10. The turbine system of claim 8, further comprising an anchor system coupled to the turbine assembly, the anchor system including a floating platform having at least one sensor and an anchor line coupled to an anchor point disposed under fluid and/or within the fluid flow on a projection of the turbine assembly in a plane normal to a flow direction or the floating platform and aligned with a center of drag of the turbine, the anchor point and the anchor line configured to one or more of: (1) move in at least one of a vertical direction or a direction parallel to the axis of the shaft when the shaft is actuated in the vertical direction or a direction parallel to the axis of the shaft; or (2) be entirely removed from the fluid upon sensing debris.

11. The turbine system of claim 8, wherein the turbine assembly comprises:
a shaft having an axis,
a single cam with a cam profile and coupled to the shaft;
at least one foil coupled to the cam and having an axis, the at least one foil configured to rotate one of about or parallel to the axis of the at least one foil while simultaneously rotating about the axis of the shaft; and
a variable pitch mechanism coupled to at least one of the at least one foil or the single cam and configured to adjust at least one of a rotational position or an angle of attack (AOA) of the at least one foil while the at least one foil simultaneously rotates about the shaft,
wherein at least one of the shaft or the variable pitch mechanism is configured to be actuated in a direction parallel to the axis of the shaft.

12. The turbine system of claim 8, wherein the at least one sensor comprises at least one of a flow velocity sensor, a debris sensor, or a surface sensor, a shaft rpm sensor, each of which is coupled to a data acquisition unit coupled to the turbine assembly.

13. The turbine system of claim 12, wherein the flow velocity sensor includes at least one of a mechanical sensor, a radar, an ultrasonic sensor, an inductive sensor, or an accelerometer, the debris sensor includes at least one of a sonar sensor, a camera, an ultrasonic sensor, a below-water sonar system, a below-water imaging system, a tension sensor, an accelerometer, and the surface sensor includes at least one of pressure column, an accelerometer, a camera, or thermal imaging camera.

14. The turbine system of claim 8, wherein the input sensed by the at least one sensor is debris.

15. A variable pitch mechanism configured for a hydrokinetic turbine assembly, the variable pitch mechanism comprising at least one actuator coupled to a cam of the hydrokinetic turbine assembly,
wherein the at least one actuator actuates the cam to move the cam in a vertical direction and disengage the cam from the turbine assembly while at least one foil of the hydrokinetic turbine assembly initially continues to rotate about an axis of foil.

16. The variable pitch mechanism of claim 15, wherein the actuator comprises at least one of: (1) a motor configured to be coupled to the cam of the hydrokinetic turbine assembly; (2) a spring and/or a damper coupled to the cam; or (3) a solenoid coupled the cam.

17. The variable pitch mechanism of claim 15, wherein the turbine assembly further comprising a follower arm and a follower wheel, the follower arm having a first end coupled to the at least one the foil and a second end coupled to the follower wheel, and the follower wheel configured to contact one or more of the single cam, linkage or a gear train disposed on the single cam.

18. The variable pitch mechanism of claim 17, wherein the turbine assembly is a hydrokinetic turbine assembly, and the at least one foil includes a first end coupled to the at least one rotor extending from the cam and a second end disposed in water.

19. The variable pitch mechanism of claim 15, wherein the at least one foil comprises a plurality of foils, each foil of the plurality of foils coupled to the cam, and the variable pitch mechanism coupled to one of each foil of the plurality of foils or the single cam and configured to adjust a position of each foil of the plurality of foils while each foil of the plurality of foils simultaneously rotates about the shaft.

20. A turbine system comprising:
the at least one actuator of the variable pitch mechanism of claim 15,
the turbine assembly comprising a hydrokinetic turbine assembly and coupled to the actuator;
at least one sensor;
wherein the actuator actuates the turbine assembly in a vertical direction in response to an input sensed by the at least one sensor.

21. A method of automatically adjusting a vertical or a rotational position of a turbine assembly, the method comprising:
sensing an input detected by at least one sensor of a turbine system;
automatically actuating at least one of: (1) a shaft of a turbine assembly via an actuator to move at least one of the shaft or the turbine assembly; (2) a single cam of the turbine assembly to move and disengage the single cam from a variable pitch mechanism of the turbine assembly; and (3) at least one foil of the turbine assembly by the variable pitch mechanism to adjust one or more of a rotational position or a vertical position of the at least one foil of the turbine assembly.

22. The method of claim 21, wherein sensing an input detected by at least one sensor of a turbine system comprising sensing debris, a maximum condition of water current, or a maximum condition of wind via one or more of a flow fluid velocity sensor, a debris sensor, or a surface sensor.

23. The method of claim 21, wherein automatically actuating at least one of a shaft of a turbine assembly via an actuator to move the shaft comprises automatically actuating the shaft of the turbine assembly via the actuator to move the shaft in an upward and/or vertical direction away from the input sensed or the turbine assembly completely out of the water.

24. The method of claim 21, wherein automatically actuating a single cam of the turbine assembly to move and disengage the single cam from the shaft of the turbine assembly comprises automatically actuating a single cam of the turbine assembly to move and disengage the single cam from the shaft of the turbine assembly in a vertical direction using an actuator.

25. The method of claim 21, wherein automatically actuating at least one foil of the turbine assembly to adjust one or more of a rotational position or a vertical position of the at least one foil of the turbine assembly while the at least one foil simultaneously rotates about the shaft of the turbine assembly comprises automatically actuating the at least one foil using the variable pitch mechanism coupled to the at least one foil, the variable pitch mechanism including at least one of: (1) a motor disposed on a rotor of the turbine assembly; or (2) a follower arm and a follower wheel coupled to the follower arm and configured to contact a linkage or a geartrain to passively adjust the rotational position of the at least one foil.
